(19) United States
(12) Patent Application Publication
(10) Pub. No.: US 2026/0073157 A1
(43) Pub. Date: Mar. 12, 2026

(54) System and Method For Automatically Marking Classification Of Textual Data

(71) Applicant: Booz Allen Hamilton Inc., Mclean, VA (US)

(72) Inventors: Steven TOMITA, McLean, VA (US); Terry Michael SCHOOF, McLean, VA (US); Sergey BLOK, McLean, VA (US)

(73) Assignee: Booz Allen Hamilton Inc., Mclean, VA (US)

(21) Appl. No.: 19/323,374

(22) Filed: Sep. 9, 2025

Related U.S. Application Data
(60) Provisional application No. 63/692,248, filed on Sep. 9, 2024.

(51) Int. Cl. G06F 40/40; G06F 40/30

(52) U.S. Cl. CPC G06F 40/40; G06F 40/30

(57) ABSTRACT

Embodiments can relate to systems and methods for autonomously marking classification of textual data. Textual data and a classification guide can be submitted to an interfacing module configured to interface a processor with a database and a large language model. A semantic search of textual data against classification rules that fall within the classification guide can be done to identify a first subset of classification rules. A curating operation of the textual data against the first subset of classification rules can be done to generate a second subset of classification rules to be used to classify the textual data. A prompt can be generated including the second subset of classification rules and instructions for a response. The prompt and textual data can be sent to the LLM to generate the response as an output document autonomously modified to include a classification marking.

### CROSS-REFERENCE TO RELATED APPLICATIONS

This patent application is related to and claims the benefit of priority of U.S. provisional Ser. No. 63/692,248 , filed on Sep. 9, 2024, the entire content of which is incorporated herein by reference.

### FIELD

Embodiments can relate to systems and methods for autonomously marking classification of textual data.

### BACKGROUND INFORMATION

Existing techniques for marking classification of textual data (e.g., classifying something as “spam” or “not spam,” or “positive” vs. “negative” sentiment, confidential vs not, etc.) can be tedious, time-consuming, and/or plagued with inaccuracies and inconsistencies. In addition, existing techniques fail to provide a means to implement various use cases while minimizing or eliminating changes to a core architecture for analyzing the textual data. In addition, existing techniques fail to provide a framework for agnostic use of different large language models (LLMs) without having to fine-tune the LLM to correctly mark classifications of textual data. Moreover, existing techniques tend to focus on techniques that either ignore classification needs or depend on the data to already be appropriately marked.

Known techniques can be appreciated from U.S. Pat. Nos. 11,860,914, 11,861,320, 11,861,321, US 2023/0368284, US 2024/0046318, US 2024/0104305, US 2024/0111498, CN 117112852, and CN 117290485.

### SUMMARY

An exemplary embodiment can relate to a system for autonomously marking classification of textual data. The system can include a processor including an interfacing module configured to interface the processor with a database and a large language model (LLM). The system can include a memory having instructions stored thereon that when executed by the processor can cause the processor, via a context management module, to perform one or more of the functions disclosed herein. Instructions cause the processor to perform a semantic search of textual data against classification rules stored in a vector database to identify a first subset of classification rules to be used to classify the textual data.

Instructions cause the processor to perform a curating operation of the textual data against the first subset of classification rules to generate a second subset of classification rules to be used to classify the textual data. Instructions cause the processor to generate a prompt including the second subset of classification rules and instructions for use by the LLM to produce a response. Instructions cause the processor to send the prompt and the textual data to the LLM to generate the response as an output document autonomously modified to include a (i) one or more classification markings for one or more portions of the textual data, or (ii) no classification marking if the classification rules do not identify a corresponding classification marking for any of the textual data.

An exemplary embodiment can relate to a system for autonomously marking classification of textual data. The system can include an Application Program Interface (API) module. The system can include a processor. The system can include a memory. The system can include an interfacing module configured to interface a database and a large language model (LLM). The system can include a plug-in data classifier application configured to support features of a software application. When executed by a processor, the plug-in data classifier application can cause the processor, via a context management module, to perform one or more functions disclosed herein. The plug-in data classifier application can cause the processor to perform a semantic search of textual data against classification rules stored in a vector database to identify a first subset of classification rules to be used to classify the textual data. The plug-in data classifier application can cause the processor to perform a curating operation of the textual data against the first subset of classification rules to generate a second subset of classification rules to be used to classify the textual data. The plug-in data classifier application can cause the processor to generate a prompt including the second subset of classification rules and instructions for use by the LLM to produce a response. The plug-in data classifier application can cause the processor to send the prompt and the textual data to the LLM to generate the response. The plug-in data classifier application can cause the processor to send the response via the API module to the plug-in data classifier application to cause the software application to generate an output, the output including a document automatically modified to include (i) one or more classification markings for one or more portions of the textual data, or (ii) no classification marking if the classification rules do not identify a corresponding classification marking for any of the textual data.

An exemplary embodiment can relate to a database management system for efficient curating of classification rule selection. The system can include a database containing classification rules. The system can include a processor including an interfacing module configured to interface the processor with the database and a large language model (LLM). The system can include a memory having instructions stored thereon that when executed by the processor can cause the processor, via a context management module, to perform one or more of the functions disclosed herein. The instructions can cause the processor to perform a semantic search of textual data against the classification rules stored in a vector database to identify a first subset of classification rules to be used to classify the textual data. The instructions can cause the processor to perform a curating operation of the textual data against the first subset of classification rules to generate a second subset of classification rules to be used to classify the textual data. The instructions can cause the processor to generate a prompt including the second subset of classification rules, the prompt configured to be executed in the LLM.

An exemplary embodiment can relate to a method for autonomously marking classification of textual data. The method can involve submitting textual data and a classification guide to an interfacing module configured to interface a processor with a database and a large language model (LLM). The method can involve performing a semantic search of textual data against classification rules stored in a vector database that fall within the classification guide to identify a first subset of classification rules to be used to classify the textual data. The method can involve performing a curating operation of the textual data against the first subset of classification rules to generate a second subset of classification rules to be used to classify the textual data. The method can involve generating a prompt including the second subset of classification rules and instructions for a response. The method can involve sending the prompt and textual data to the LLM to generate the response as an output document automatically modified to include (i) one or more classification markings for one or more portions of the textual data, or (ii) no classification marking if the classification rules do not identify a corresponding classification marking for any of the textual data.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary system for autonomously marking classification of textual data;

FIG. 2 shows an exemplary plug-in data classifier application for autonomously marking classification of textual data;

FIG. 3 shows an exemplary database management system for efficient curating of classification rule selection;

FIG. 4 show an exemplary method for autonomously marking classification of textual data;

FIG. 5 shows an exemplary block diagram for an embodiment of the system;

FIG. 6 shows an exemplary data flow diagram; and

FIG. 7 shows an exemplary Retrieval-Augmented Generation architecture that can be used for an embodiment of the system.

### DETAILED DESCRIPTION

Embodiments can relate to systems and methods that autonomously classify text of a document. A document can be provided (e.g., submitted, retrieved, etc.) to the system, wherein the system identifies the text as falling within a category or classification based on the contents of the textual data. For instance, the document might contain a paragraph that relates to sensitive information (e.g., confidential, classified, top secret, etc.). A user can submit the document, and the system can determine, via predictive language model(s), which textual portions (e.g., paragraphs) of the document contain sensitive information. The system can further determine the nature of the sensitive information so as to autonomously classify (or label) the textual portion as falling within a category (e.g., confidential, classified, top secret, etc.). The system can automatically mark the document to identify the textual portions that contain sensitive information and identify the category or type (e.g., label the textual data) of the sensitive information. The marked-up document can then be presented to a user via a user interface, sent to a user for a user to review, etc. Known techniques use predictive language models, but they rely on a prefilled list of labels (e.g., classifiers) that a user has to be aware of. Further, the user has to be a subject matter expert to know which labels to use and how to use them—i.e., it is an arduous and inconsistent process. For instance, the labelling in conventional systems requires a great deal of human interaction and is very much subjective.

Even with the use of automated techniques that map security classification guide rules to textual contexts, conventional systems are time-consuming. Furthermore, known techniques cannot label a textual portion (e.g., a paragraph) of the document, but are rather limited to labelling the entire document.

As will be explained herein, embodiments of the system utilize a framework that can integrate a Retrieval-Augmented Generation (RAG) into the system so that the information retrieval system operates in conjunction with a generative large language model (LLM) in an improved way. For instance, the framework configuration can take into account classification needs and does not depend on the data to be already appropriately marked. In addition, instead of exposing the LLM program and a vector database to the end user, the system can manage the conversation with the LLM to achieve a deterministic response for repeatable processing. The system can implement different use cases without having to change the core of framework. This allows for implementation of different use cases without having to fine-tune the LLM.

Typically, fine-tuning the LLM is required to achieve high accuracy when implementing different use cases, but the system can obviate the need for fine-tuning without risking loss of accuracy.

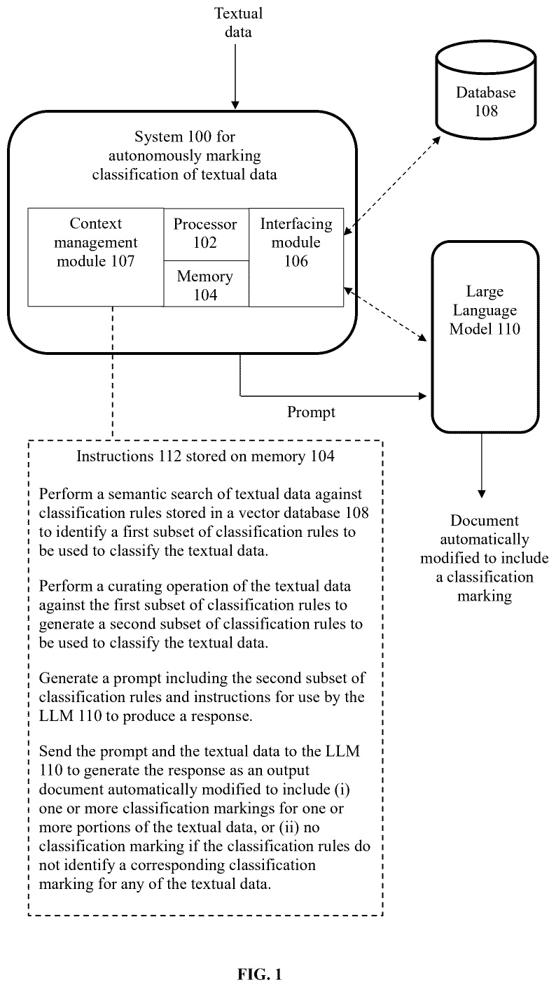

Referring to FIG. 1, an exemplary embodiment can relate to a system 100 for autonomously marking classification of textual data. The system 100 can include a processor 102. The processor 102 can include an interfacing module 106 configured to interface the processor 102 with a database 108 and a large language model (LLM) 110. The database 108 and/or the LLM 110 can be part of the system 100, separate from the system 100 but in communication with the system 100, etc. The system 100 can include a memory 104 having instructions 112 stored thereon that when executed by the processor 102 can cause the processor 102 to perform one or more of the functions disclosed herein. In some embodiments, the processor 102 can perform one or more of the functions via a context management module 107.

A user can submit one or more documents (e.g., a Word file, a PDF file, etc.) to the system 100. This can be done by uploading the document via a user interface, for example. A user can also submit classification guides (e.g., security classification guides (“SCGs”)), which can be a set of classification rules the user wants the system to focus on. These can submitted via the user interface via upload, textual input, etc. As will be explained herein, the system 100 can analyze the document to identify portion(s) (e.g., paragraphs(s), sentence(s), phrase(s), passage(s), section(s), etc.) that contain or relate to sensitive information. The system 100 can also classify or label that/those portion(s) according to the type or category of sensitive information (e.g., confidential, top secret, etc.). The system 100 can then automatically mark the portion(s) according to the label and generate a marked-up version of the document with the labelled portion(s). For instance, the system 100 can include a text box within the document and next to the textual data that indicates the label, and the textual data can be highlighted in a color, etc.

After being submitted to the system 100, instructions 112 can cause the processor to perform a semantic search of textual data against classification rules stored in a vector database 108. This can be done to identify a first subset of classification rules to be used to classify the textual data. For instance, the database 108 can be a vector database that contains all of the possible classification rules to classify (or label) the textual data. One or more of these classification rules can be stored as mathematical representations. The system 100 can utilize a Retrieval-Augmented Generation (RAG) dataflow and vectorization process, for example, to perform a semantic search against the classification rules. This semantic search can identify a first subset of classification rules (e.g., identify the top 10 classification rules). For instance, the RAG and vectorization process can be used to identify a first subset of classification rules that the textual data most closely relates to. For example, the semantic search process can include analyzing the textual data, scanning the classification rules in the vector database, and comparing the classification rules to the classification guides to identify the first subset of classification rules. The RAG and vectorization process can be configured to only use vectors from the classification guides (e.g., the classification rules submitted by the user), which facilitates narrowing the classification rules to the first subset.

Instructions 112 can cause the processor 102 to perform a curating operation of the textual data against the first subset of classification rules to generate a second subset of classification rules to be used to classify the textual data. This curating operation can be performed against the first subset of classification rules to generate a second subset (e.g., identify the top 5 classification rules) of classification rules. The curating step can be performed using cross-encoders and embedding processes to perform a similarity process (e.g., Euclidian distance) that identifies textual data as being most closely related to the classification rules.

Instructions 112 can cause the processor 102 to generate a prompt including the second subset of classification rules and instructions for use by the LLM to produce a response. Instructions 112 can cause the processor 102 to send the prompt and the textual data to the LLM 110 to generate the response as an output document autonomously modified to include (i) one or more classification markings for one or more portions of the textual data, or (ii) no classification marking if the classification rules do not identify a corresponding classification marking for any of the textual data. For instance, the processor 102 can package the second subset of classification rules as a prompt. The processor 102 can send the prompt to the LLM. The prompt can be configured to provide the LLM with the textual data to be classified (or labelled). The LLM can use one or more predictive language processes to generate a response (e.g., determination and explanation). The prompt can also be configured to instruct the LLM of which architecture to use to generate the response, e.g., generate an output in a JSON format. The LLM can generate the response as a report (e.g., display the document with the labelled portion(s) (paragraph(s) via a GUI that shows the portion(s) and the proposed classification for a user to verify). For instance, the LLM can parse the textual data to generate the response and package the response into the JSON format.

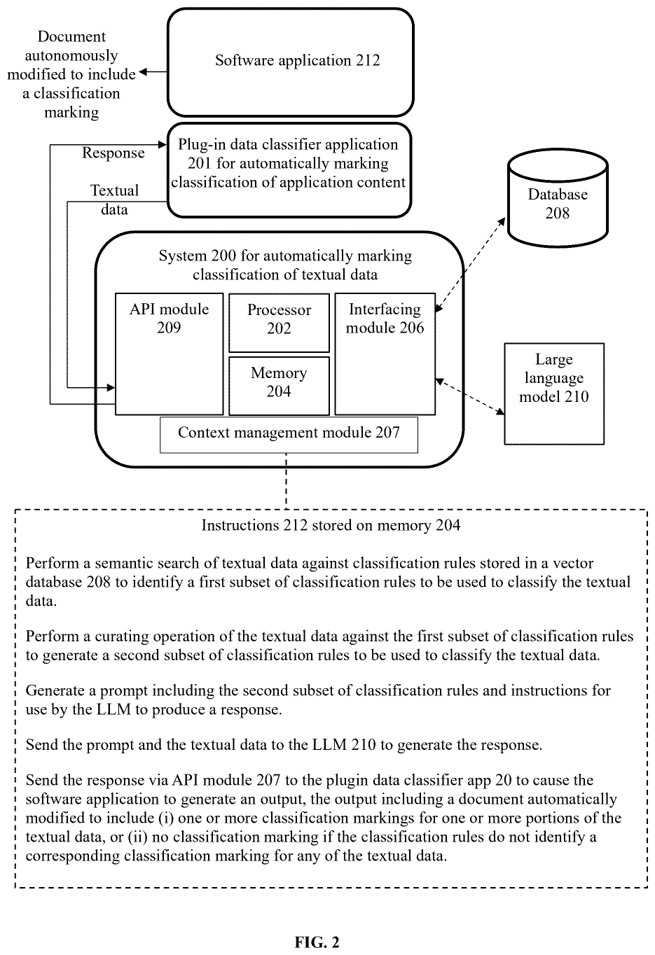

The following discussion pertains to FIGS. 2-4, which discuss additional embodiments. Some of the embodiments utilize features (e.g., databases, semantic search processes, curation processes, etc.) that are also used in the system pertaining to FIG. 1. FIGS. 2-4 can use the same or different features as those used in in FIG. 1. Unless otherwise stated, the features in FIGS. 2-4 can include at least the aspects discussed above for FIG. 1.

Referring to FIG. 2, an exemplary embodiment can relate to a system 200 for autonomously marking classification of textual data. The system 200 can include an Application Program Interface (API) module 209. The system 200 can include a processor 202. The system 200 can include a memory 204. The system 200 can include an interfacing module 206 configured to interface a database 208 and a large language model (LLM) 210.

The system 200 can include a plug-in data classifier application 201 configured to support features of a software application 212 (e.g., an add-in). When executed by the processor 202, the plug-in data classifier application 201 can cause the processor 202 to perform one or more of the functions disclosed herein. This can involve performing one or more of the functions via a context management module 207.

The plug-in data classifier application 201 can cause the processor 202 to perform a semantic search of textual data against classification rules stored in a vector database 208 to identify a first subset of classification rules to be used to classify the textual data. The plug-in data classifier application 201 can cause the processor 202 to perform a curating operation of the textual data against the first subset of classification rules to generate a second subset of classification rules to be used to classify the textual data. The plug-in data classifier application 201 can cause the processor 202 to generate a prompt including the second subset of classification rules and instructions for use by the LLM 210 to produce a response. The plug-in data classifier application 201 can cause the processor 202 to send the prompt and the textual data to the LLM 210 to generate the response. The plug-in data classifier application 201 can cause the processor 202 to send the response via the API module 209 to the plug-in data classifier application 201 to cause the software application 212 to generate an output, the output including a document autonomously modified to include (i) one or more classification markings for one or more portions of the textual data, or (ii) no classification marking if the classification rules do not identify a corresponding classification marking for any of the textual data.

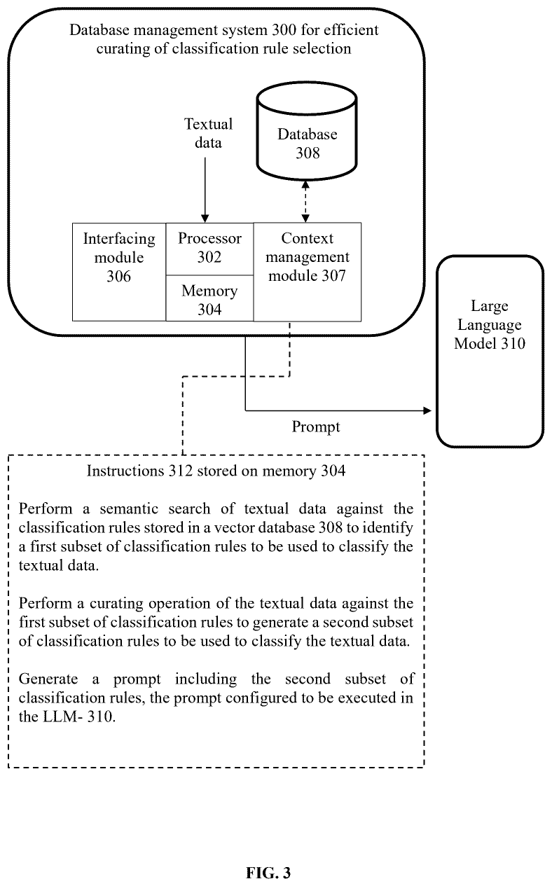

Referring to FIG. 3, embodiments can relate to a database management system 300 for efficient curating of classification rule selection. The system 300 can include a database 308 containing classification rules. The system 300 can include a processor 302 including an interfacing module 306 configured to interface the processor 302 with the database 308 and a large language model (LLM) 310. The system 300 can include a memory 304 having instructions 312 stored thereon that when executed by the processor 302 can cause the processor 302 to perform one or more of the functions disclosed herein. This can involve performing one or more of the functions via a context management module 307.

Instructions 312 can cause the processor 302 to perform a semantic search of textual data against the classification rules stored in a vector database 308 to identify a first subset of classification rules to be used to classify the textual data. Instructions 312 can cause the processor 302 to perform a curating operation of the textual data against the first subset of classification rules to generate a second subset of classification rules to be used to classify the textual data. Instructions 312 can cause the processor 302 to generate a prompt including the second subset of classification rules, the prompt configured to be executed in the LLM 310.

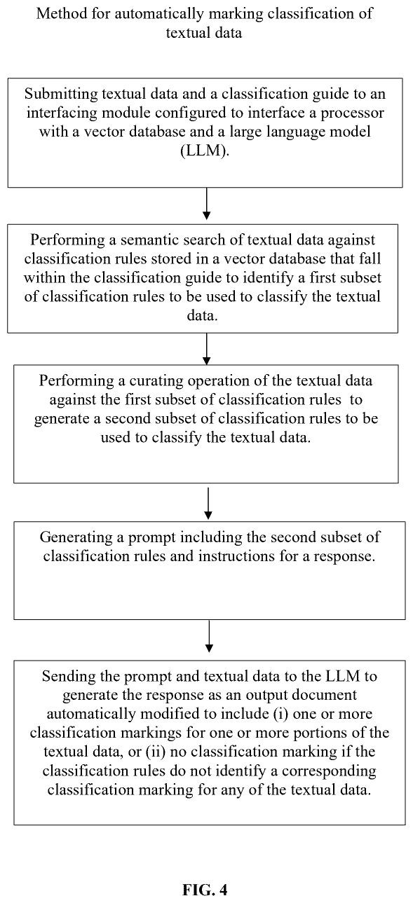

Referring to FIG. 4, embodiments can relate to a method for autonomously marking classification of textual data. The method can involve submitting textual data and a classification guide to an interfacing module configured to interface a processor with a database and a large language model (LLM). The method can involve performing a semantic search of textual data against classification rules stored in a vector database that fall within the classification guide to identify a first subset of classification rules to be used to classify the textual data. The method can involve performing a curating operation of the textual data against the first subset of classification rules to generate a second subset of classification rules to be used to classify the textual data. The method can involve generating a prompt including the second subset of classification rules and instructions for a response. The method can involve sending the prompt and textual data to the LLM to generate the response as an output document autonomously modified to include (i) one or more classification markings for one or more portions of the textual data, or (ii) no classification marking if the classification rules do not identify a corresponding classification marking for any of the textual data.

While exemplary embodiments may describe and/or illustrate one processor and one memory, it is understood that the system can include any number of processors and memories.

The processor can be any of the processors disclosed herein. The processor can be part of or in communication with a machine (logic, one or more components, circuits (e.g., modules), or mechanisms). The processor can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. Use of processors herein can include any one or combination of a Graphics Processing Unit (GPU), a Field Programmable Gate Array (FPGA), a Central Processing Unit (CPU), etc. The processor can include one or more processing modules. A processing module can be a software or firmware operating module configured to implement any of the method steps disclosed herein. The processing module can be embodied as software and stored in memory, the memory being operatively associated with the processor. A processing module can be embodied as a web application, a desktop application, a console application, etc.

The processor can include or be associated with a computer or machine readable medium. The computer or machine readable medium can include memory. The computer or machine readable medium can be configured to store one or more instructions thereon. The instructions can be in the form of algorithms, program logic, a model, etc. that cause the processor to perform any of the functions described herein.

Any of the memory discussed herein can be computer readable memory configured to store data. The memory can include a volatile or non-volatile, transitory or non-transitory memory, and be embodied as an in-memory, an active memory, a cloud memory, etc. Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The processor can be in communication with other processors of other devices (e.g., a computer device, a desktop computer, a laptop computer, a computer system, etc.). Any of those other devices can include any of the exemplary processors disclosed herein. Any of the processors can have transceivers or other communication devices/circuitry to facilitate transmission and reception of wireless signals. Any of the processors can include an Application Programming Interface (API) as a software intermediary that allows two applications to talk to each other. Use of an API can allow software of the processor of the system to communicate with software of the processor of the other device(s), if the processor of the system is not the same processor of the device.

Any data transmission between the processor and memory, between the processor and a database, and between the processor and processors of other devices, etc. can be via a pull operation (e.g., the processor can pull the data) or a push operation (e.g., the data can be pushed to the processor). The processor can receive the data in steaming format, or store it in memory before being processed. In addition, embodiments of the algorithm, model, etc. disclosed herein can be developed as an application software (an “App”) to be implemented on a processor of a device. The App can be sent via a steaming format, or the App can be sent and stored on a memory associated with or accessed by the device.

As noted herein, the processor can be configured to be a component of, used in combination with, or in communication with another device/system—e.g., this can include the processor being part of the device/system, the device/system being part of the processor, the processor in communication with the device/system, etc. “Being part of” can include being on a same substrate or integrated circuit. For instance, the processor can be a component of, used in combination with, or in communication with a predictive modeling system, a decision support system, an automated control system, etc. The processor can use the model or algorithm or provide the model or algorithm to the device/system to assist with or augment the performance of these devices/systems.

### EXAMPLES

The following are exemplary systems, methods, and implementations of the embodiments disclosed herein. While the examples may focus on one implementation, it is understood that this is exemplary and the embodiments disclosed herein are not limited thereto.

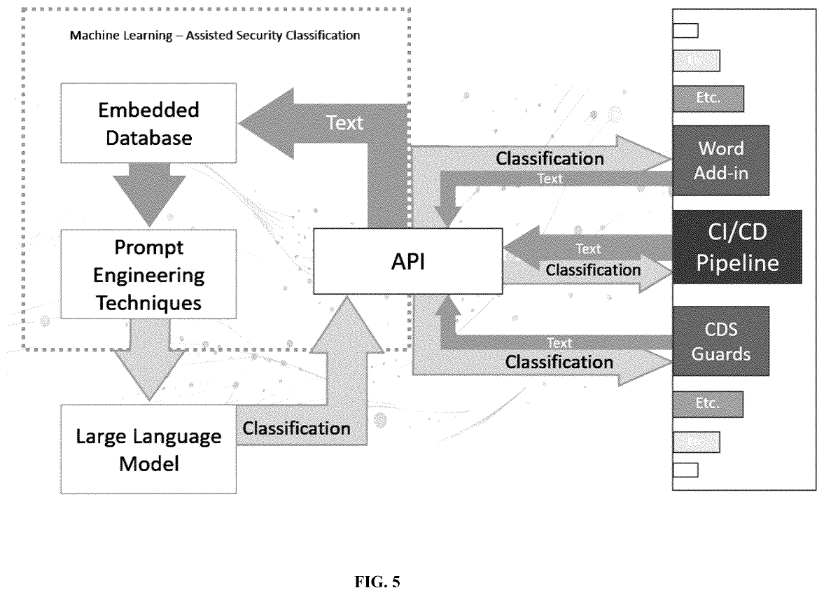

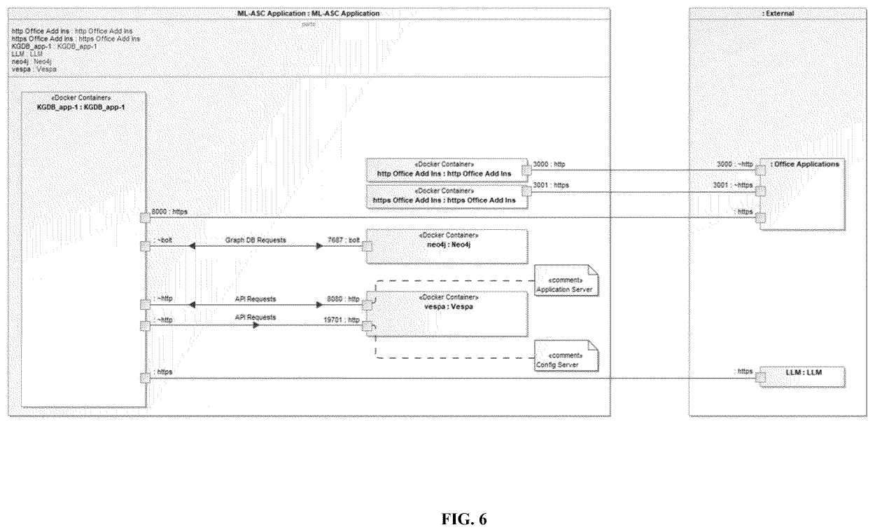

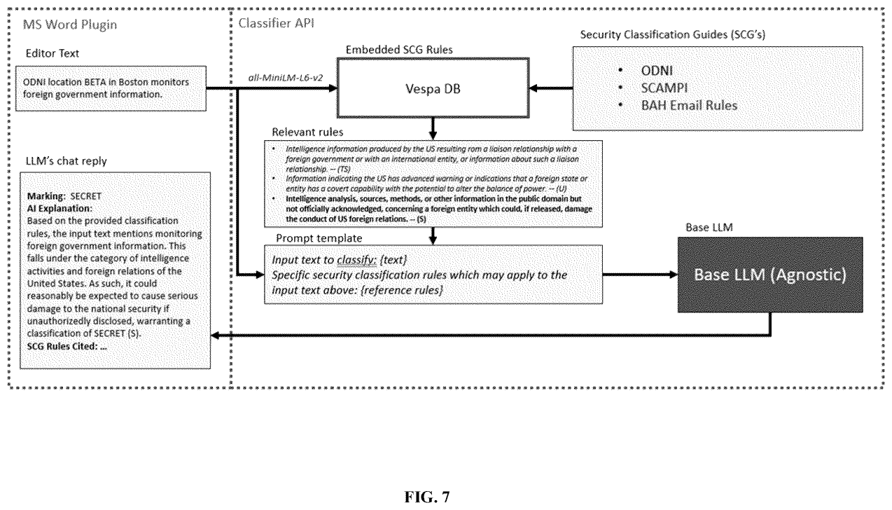

Referring to FIGS. 5-7, in an exemplary use case, a user provides a document to the system to determine which textual portion(s) of the document contains textual data related to sensitive information. The sensitive information can be categorized or classified as one or more of the following:
1. TOP SECRET (TS): information, the unauthorized disclosure of which reasonably could be expected to cause exceptionally grave damage to national security.
2. SECRET (S): information, the unauthorized disclosure of which reasonably could be expected to cause serious damage to national security.
3. CONFIDENTIAL (C): information, the unauthorized disclosure of which reasonably could be expected to cause damage to national security.
4. UNCLASSIFIED (U): information, the unauthorized disclosure of which reasonably could be expected to cause no damage to national security.

An exemplary system can include a Large Language Model (LLM). The LLM can be an artificial intelligence program that uses machine learning to generate and predict language. The system can include a vector database. The LLM can be part of the system or be external to the system. The vector database can be a collection of data that is stored as mathematical representations. The mathematical representations allow one or more machine learning models to remember previous inputs to store classification rule sets and relevant metadata. The system can include an Application Programming Interface (API) to manage connections to the vector database and to the LLM. The system can include a webserver to host add-ins (e.g., Microsoft Office Add-In) for use by a client device. The system can include a graph database to store classification document reference information.

A user can submit a document (e.g., via a user interface) to the system. A user can also submit classification guides (e.g., security classification guides (“SCGs”)). The classification guides can be a set of classification rules the user wants the system to focus on. The system can utilize a Retrieval-Augmented Generation (RAG) dataflow and vectorization to perform a semantic search against classification rules. This semantic search can identify a first subset of classification rules (e.g., identify the top 10 classification rules). For instance, the vector database contains all of the possible classification rules stored as mathematical representations. The RAG and vectorization process can be used to identify a first subset of classification rules that the textual data most closely relates to. For example, the semantic search process can include analyzing the textual data (e.g., the API can vectorize the portion(s) (e.g., paragraph(s)) of the document to allow the system to perform a semantic search against classification rules within the classification guides). The semantic search process can include scanning the classification rules in the vector database, and comparing the classification rules to the classification guides to identify the first subset of classification rules. The RAG and vectorization process only use vectors from the classification guides, which facilitates narrowing the classification rules to the first subset. It is contemplated the first subset of classification rules can include:
A base rule text content.
A label associated with the rule and corresponding classification.
Any extended metadata about the rule such as distribution statements, remarks, etc.

The system can then perform a curating step against the first subset of classification rules to generate a second subset (e.g., identify the top 5 classification rules) of classification rules. The curating step can be performed using cross-encoders and embedding processes to perform a similarity process (e.g., Euclidian distance) that identifies textual data as being most closely related to the classification rules.

The system can then package the second subset of classification rules as a prompt. The system can send the prompt to the LLM. The prompt is configured to provide the LLM with the textual data to be classified (or labelled). The LLM uses one or more predictive language processes to generate a response (e.g., determination and explanation). The prompt can also be configured to instruct the LLM which architecture to use to generate the response, e.g., generate an output in a JSON format. The LLM can generate the response as a report (e.g., display the document with the labelled portion(s) of the textual data and the proposed classification for a user to verify). For instance, the LLM can parse the textual data to generate the response and package the response into the JSON format. The LLM can transmit the response to the API, wherein the API can interface with an Add-In to generate the GUI output.

It will be understood that modifications to the embodiments disclosed herein can be made to meet a particular set of design criteria. For instance, any of the components, features, or steps of the system, apparatus, or method can be any suitable number or type of each to meet a particular objective. Therefore, while certain exemplary embodiments of the systems and methods disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiments. Thus, the components, features, and/or configurations of the various embodiments can be combined in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein. Additionally, the disclosure of a range of values is a disclosure of every numerical value within that range, including the end points.

What is claimed is:

1. A system for autonomously marking classification of textual data, comprising:
a processor including an interfacing module configured to interface the processor with a database and a large language model (LLM);
a memory having instructions stored thereon that when executed by the processor will cause the processor, via a context management module, to:
perform a semantic search of textual data against classification rules stored in a vector database to identify a first subset of classification rules to be used to classify the textual data;
perform a curating operation of the textual data against the first subset of classification rules to generate a second subset of classification rules to be used to classify the textual data;
generate a prompt including the second subset of classification rules and instructions for use by the LLM to produce a response; and
send the prompt and the textual data to the LLM to generate the response as an output document automatically modified to include (i) one or more classification markings for one or more portions of the textual data, or (ii) no classification marking if the classification rules do not identify a corresponding classification marking for any of the textual data.

2. The system of claim 1, wherein:
the database is a vector database that contains classification rules stored as mathematical representations.

3. The system of claim 1, wherein instructions will cause the processor to:
perform the semantic search via a Retrieval-Augmented Generation (RAG) dataflow and vectorization process.

4. The system of claim 3, wherein instructions will cause the processor to:
use vectors of user-identified classification guides when performing the semantic search.

5. The system of claim 4, wherein instructions will cause the processor to:
identify ten classification rules from one or more user-identified classification guides as the first subset of classification rules.

6. The system of claim 1, wherein instructions will cause the processor to:
perform the curating operation via a similarity process involving cross-encoders.

7. The system of claim 6, wherein instructions will cause the processor to:
perform the similarity process via a Euclidian distance process.

8. The system of claim 6, wherein instructions will cause the processor to:
identify five classification rules from the first subset of classification rules as the second subset of classification rules.

9. A system for autonomously marking classification of textual data, comprising:
an Application Program Interface (API) module;
a processor;
a memory;
an interfacing module configured to interface a database and a large language model (LLM);
a plug-in data classifier application configured to support features of a software application;
wherein, when executed by a processor, the plug-in data classifier application will cause the processor, via a context management module, to:
perform a semantic search of textual data against classification rules stored in a vector database to identify a first subset of classification rules to be used to classify the textual data;
perform a curating operation of the textual data against the first subset of classification rules to generate a second subset of classification rules to be used to classify the textual data;
generate a prompt including the second subset of classification rules and instructions for use by the LLM to produce a response;
send the prompt and the textual data to the LLM to generate the response; and
send the response via the API module to the plug-in data classifier application to cause the software application to generate an output, the output including a document automatically modified to include (i) one or more classification markings for one or more portions of the textual data, or (ii) no classification marking if the classification rules do not identify a corresponding classification marking for any of the textual data.

10. A database management system for efficient curating of classification rule selection,
comprising:
a database containing classification rules;
a processor including an interfacing module configured to interface the processor with the database and a large language model (LLM);
a memory having instructions stored thereon that when executed by the processor will cause the processor, via a context management module, to:
perform a semantic search of textual data against the classification rules stored in a vector database to identify a first subset of classification rules to be used to classify the textual data;
perform a curating operation of the textual data against the first subset of classification rules to generate a second subset of classification rules to be used to classify the textual data;
generate a prompt including the second subset of classification rules, the prompt configured to be executed in the LLM to generate a response.

11. A method for autonomously marking classification of textual data, the method
comprising:
submitting textual data and a classification guide to an interfacing module configured to interface a processor with a database and a large language model (LLM);
performing a semantic search of textual data against classification rules stored in a vector database that fall within the classification guide to identify a first subset of classification rules to be used to classify the textual data;
performing a curating operation of the textual data against the first subset of classification rules to generate a second subset of classification rules to be used to classify the textual data;
generating a prompt including the second subset of classification rules and instructions for a response; and
sending the prompt and textual data to the LLM to generate the response as an output document automatically modified to include (i) one or more classification markings for one or more portions of the textual data, or (ii) no classification marking if the classification rules do not identify a corresponding classification marking for any of the textual data.

12. The method of claim 11, wherein:
the database is a vector database that contains possible classification rules stored as mathematical representations.

13. The method of claim 11, wherein:
performing the semantic search involves a Retrieval-Augmented Generation (RAG) dataflow and vectorization process.

14. The method of claim 13, wherein:
using vectors of user-identified classification guides when performing the semantic search.

15. The method of claim 14, comprising:
identifying ten classification rules from the classification guides as the first subset of classification rules.

16. The method of claim 11, comprising:
performing the curating operation via a similarity process involving cross-encoders.

17. The method of claim 16, comprising:
performing the similarity process via a Euclidian distance process.

18. The method of claim 17, comprising:
identifying five classification rules from the first subset of classification rules as the second subset of classification rules.
